(19) United States
(12) Patent Application Publication
(10) Pub. No.: US 2026/0326854 A1
(43) Pub. Date: Oct. 22, 2026

(54) ELECTRIC VEHICLE

(71) Applicant: KAWASAKI MOTORS, LTD., Akashi-shi (JP)

(72) Inventors: Tadashi NARUMI, Akashi-shi (JP); Koki NAGAO, Akashi-shi (JP); Takeshi NAKAJIMA, Akashi-shi (JP)

(21) Appl. No.: 19/647,284

(22) Filed: Apr. 14, 2026

(30) Foreign Application Priority Data
Apr. 16, 2025 (JP) 2025-067210

(51) Int. Cl. B62M 7/02; B62J 43/20

(52) U.S. Cl. CPC B62M 7/02; B62J 43/20

(57) ABSTRACT

An electric vehicle comprises a vehicle frame, a swing arm, a rear wheel, a motor, an output unit, and a looped transmission member. The vehicle frame includes a pivot axis. The arm is pivotably connected to the pivot axis. The rear wheel is rotatably supported by the arm. The motor is fixed to the vehicle frame. The output unit includes a housing fixed to the motor. The output unit transmits driving force of the motor and outputs the driving force to an output shaft provided in the housing. The member is attached to the output shaft and the rear wheel, and transmits the output of the output shaft to the rear wheel. The housing is fixed to the vehicle frame at at least a first fixed position. The pivot axis and the first fixed position are located, in a side view, within a region surrounded by the member.

### TECHNICAL FIELD

This disclosure relates to an electric vehicle.

### BACKGROUND ART

Conventionally, electric vehicles that run by driving force of a motor are known. PTL 1 discloses this type of electric vehicle.

The electric vehicle according to PTL 1 comprises: a pair of upper frames; a pair of lower frames; a rear frame connecting rear portions of the pair of upper frames and rear portions of the pair of lower frames; a pair of rear wheels; a drive motor that drives the pair of rear wheels; an endless power transmission member connecting the drive motor to the pair of rear wheels; a pivot axis attached to the rear frame; and a swing arm pivotally supported by the pivot axis and supporting the pair of rear wheels, wherein the drive motor is positioned forward of the swing arm.

PTL 1: Japanese Patent Application Laid-Open No. 2023-092285.

In the electric vehicle according to PTL 1, the drive motor and rear wheels are connected via a power transmission member. Therefore, mechanical loads acting on the rear wheels from the road surface, etc., are transmitted to the drive motor via the power transmission member.

### SUMMARY

The present disclosure relates to reduction of the load on the motor of an electric vehicle.

According to an aspect of the present disclosure, an electric vehicle having the following configuration is provided.

That is, the electric vehicle includes a vehicle frame, a swing arm, a rear wheel, a motor, an output unit, and a transmission member. The vehicle frame has a pivot axis. The swing arm is pivotably connected to the pivot axis. The rear wheel is rotatably supported by the swing arm. The motor is fixed to the vehicle frame. The output unit includes a housing fixed to the motor. The output unit transmits driving force of the motor and outputs the driving force to an output shaft provided in the housing. The transmission member is loop-shaped and is attached to the output shaft and the rear wheel. The transmission member transmits the output of the output shaft to the rear wheel. The housing is fixed to the vehicle frame at at least a first fixed position. The pivot axis and the first fixed position are located, in a side view, within a region surrounded by a looped transmission member.

As a result, mechanical loads acting on the rear wheel from the road surface or the like are transmitted via the looped transmission member to the output shaft provided in the housing of the output unit. Since the housing including the output shaft is fixed to the vehicle frame at least at the first fixed position, the mechanical load can be supported by the vehicle frame. Here, the first fixed position is within the region surrounded by the looped transmission member together with the pivot axis in a side view. Thus, the housing of the output unit is fixed near the pivot axis, that is, to a highly rigid portion of the vehicle frame. Therefore, the mechanical load transmitted to the output shaft can be supported particularly stably. Furthermore, since the housing is fixed to the motor, the above mechanical load is also transmitted to the motor. Since the motor is fixed to the vehicle frame, the mechanical load transmitted to the motor can also be supported by the vehicle frame. As described above, the mechanical load acting on the rear wheel is transmitted to the housing of the output unit and the motor via the transmission member. However, since both the housing and the motor are fixed to the vehicle frame, the mechanical load can be stably supported by the vehicle frame.

According to the present disclosure, the load on the motor of an electric vehicle can be reduced.

### BRIEF DESCRIPTION OF THE DRAWINGS

FIG. 1 is a side view of an electric vehicle according to one embodiment of the present disclosure, as viewed from the left.

FIG. 2 is a side view of an electric vehicle according to one embodiment of the present disclosure, as viewed from the right.

FIG. 3 is a side view of the periphery of the motor unit, enlarged and as viewed from the left.

FIG. 4 is a perspective view of the periphery of the output unit of the motor unit, enlarged and as viewed from the left.

FIG. 5 is a side view of the periphery of the motor unit, enlarged and as viewed from the right.

FIG. 6 is a perspective view of the periphery of the motor unit, enlarged and as viewed from the right.

### DETAILED DESCRIPTION

Next, the embodiments of the present application will be described with reference to the drawings. In the following description, the front direction refers to the direction in which an electric vehicle 1 travels forward. The rear direction, left direction, and right direction each refer to the corresponding direction relative to a driver straddling the electric vehicle 1 in an upright position on the ground, respectively. In each of the drawings, the front direction of the electric vehicle 1 is indicated by arrow D1. The vertical upward direction and downward direction are defined as the upward and downward, respectively. Furthermore, terms used to describe positional relationships, size or shape etc., shall include not only the state in which the meaning of the term is fully satisfied, but also the state in which the meaning of the term is approximately satisfied. When it is stated that “A is attached to B”, it shall include not only configurations in which A is directly attached to B, but also configurations in which A is attached to B via other attachment members, etc.

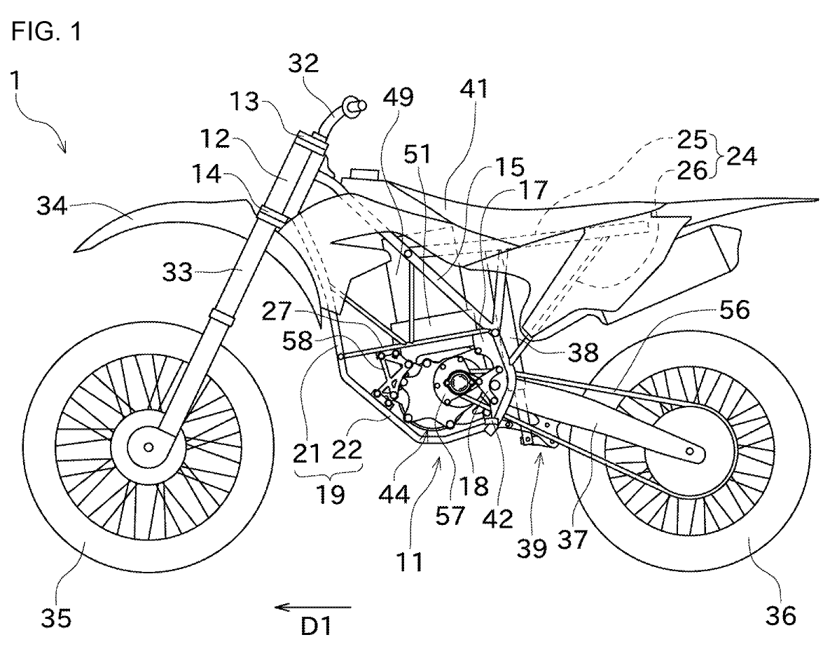

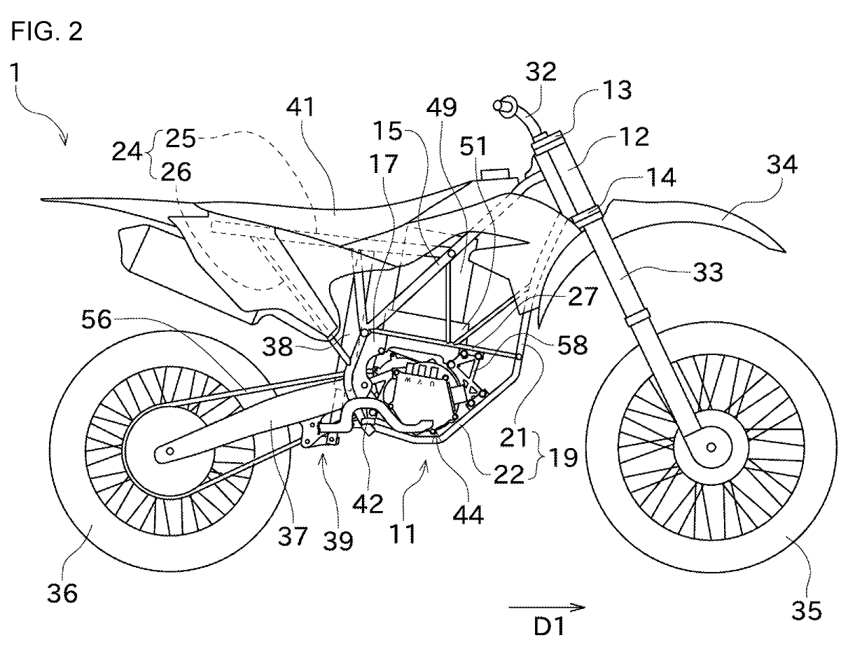

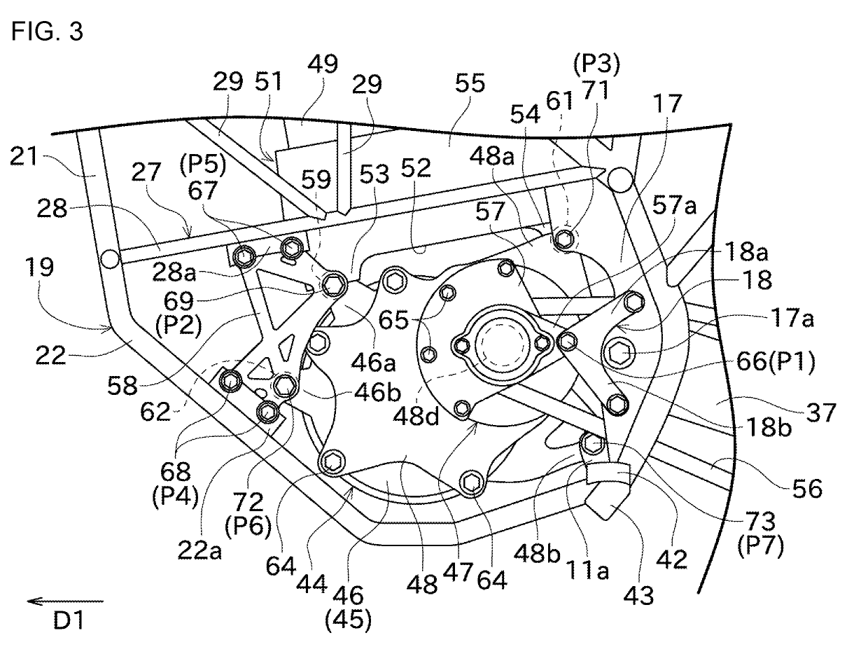

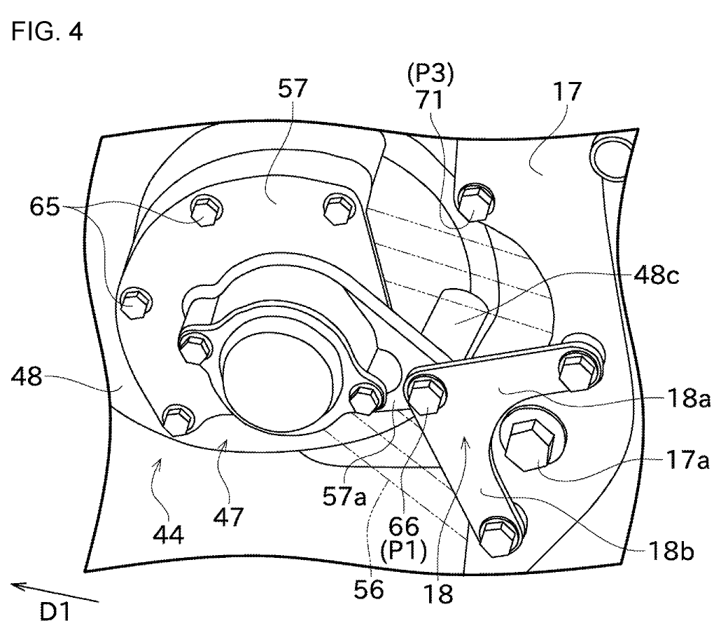

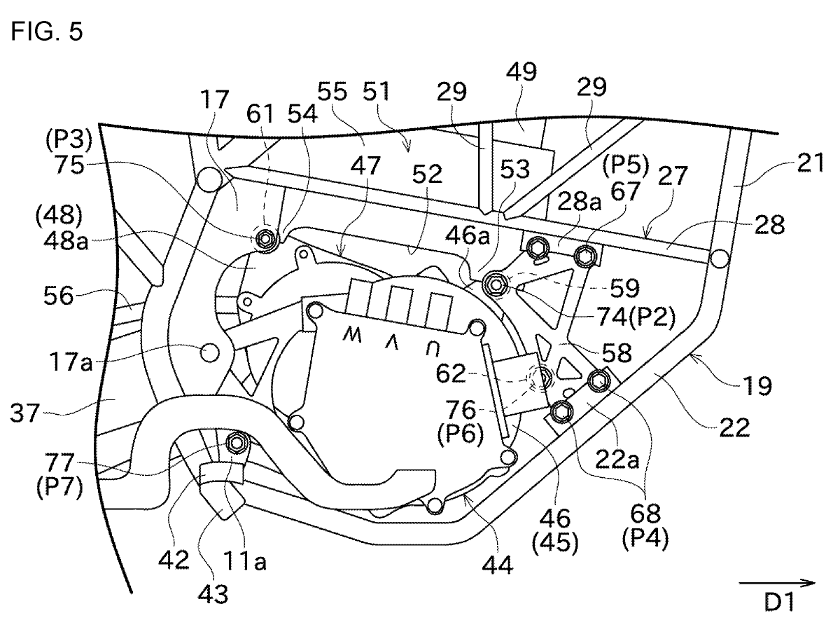

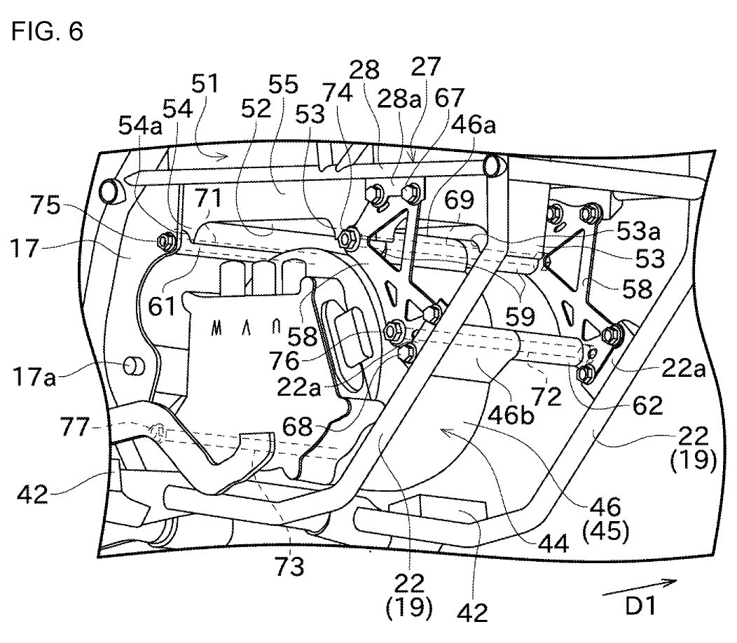

FIG. 1 is a side view of the electric vehicle 1 according to the present embodiment, as viewed from the left. FIG. 2 is a side view of the electric vehicle 1 according to the present embodiment, as viewed from the right. FIG. 3 is a side view of the periphery of the motor unit 44, enlarged and as viewed from the left. FIG. 4 is a perspective view of the periphery of an output unit 47 of the motor unit 44, enlarged and as viewed from the left. FIG. 5 is a side view of the periphery of the motor unit 44, enlarged and as viewed from the right. FIG. 6 is a perspective view of the periphery of the motor unit 44, enlarged and as viewed from the right.

As shown in FIGS. 1 and 2, the electric vehicle 1 of the present embodiment is configured as a straddle-type motorcycle. The electric vehicle 1 is also a motocross type vehicle, primarily intended for travel on unpaved surfaces. The electric vehicle 1 includes a vehicle frame 11. The vehicle frame 11 includes a head pipe 12, a main frame 15, a lower frame 19, a pivot frame 17, a rear frame 24, and a reinforcement frame 27.

The head pipe 12 has a substantially cylindrical shape extending substantially vertically. The head pipe 12 has a shaft insertion hole extending in its longitudinal direction (or substantially vertically). A steering shaft (not shown) is inserted into the shaft insertion hole.

An upper bracket 13 is attached to the upper portion of the head pipe 12, and a lower bracket 14 is attached to the lower portion. The upper bracket 13 and the lower bracket 14 each include a fork insertion hole for inserting a pair of front forks 33 arranged on the left and right sides. This configuration allows the upper bracket 13 and the lower bracket 14 to support the upper portion of the front fork 33. A front wheel 35 is rotatably attached to the lower portion of the front fork 33. A steering handle 32 is attached to the upper bracket 13. This configuration allows a driver to steer the electric vehicle 1 by turning the steering handle 32. A front fender 34, which covers the upper portion of the front wheel 35, is attached to the lower bracket 14.

The main frame 15 is connected to the head pipe 12 (more specifically, to the rear of the upper half of the head pipe 12). The main frame 15 is arranged to extend rearwardly (diagonally downward and rearward) from the head pipe 12. The main frame 15 is provided as a pair on the left and right. A rear frame mounting portion (not shown) is provided on the intermediate portion of the main frame 15 for attaching the rear frame 24.

As shown in FIG. 1, etc., the lower frame 19 is connected to the head pipe 12 (more specifically, to the rear of the lower half of the head pipe 12). The lower frame 19 is arranged to extend substantially downwardly from the head pipe 12. The lower frame 19 is provided as a pair on the left and right, each of which includes an upper lower frame 21 and a lower lower frame 22.

The upper end of the upper lower frame 21 is connected to the head pipe 12. The upper lower frame 21 extends downwardly from the head pipe 12. The lower lower frame 22 is connected to the lower end of the upper lower frame 21.

The lower lower frame 22 is formed in a curved shape that is convex downwardly or forwardly and downwardly. The front end of the lower lower frame 22 is connected to the upper lower frame 21, and the rear end is connected to the pivot frame 17.

As shown in FIG. 1, etc., the pivot frame 17 is arranged to extend substantially vertically. The upper end of the pivot frame 17 is connected to the main frame 15 and the lower end is connected to the lower lower frame 22. The pivot frame 17 is a highly rigid component among the vehicle frame 11, since a swing arm 37 (described later) that supports a rear wheel 36 is attached thereto. The pivot frame 17 is formed in a curved shape that is convex rearwardly. The pivot frames 17 are provided as a pair on the left and right, and are connected to each other at their upper and lower ends by a connecting member (not shown).

A pivot axis 17a is located on the pivot frame 17 to connect the swing arm 37 (as shown in FIGS. 3 and 4 ). The swing arm 37 is pivotably connected to the pivot axis 17a, enabling vertical movement. The rear wheel 36 is rotatably attached to the rear of the swing arm 37. The swing arm 37 is elastically supported by a rear suspension 38. That is, the rear suspension 38 connects the intermediate portion of a seat rail 25 (specifically, a suspension mounting portion described later) to the swing arm 37 via a suspension mounting mechanism 39. This configuration allows for the absorption of impacts received by the rear wheel 36 from the road surface.

The pivot frame 17 includes a fixing plate 18 that is used to fix a motor unit 44 and a cover 57, described below. The fixing plate 18 is substantially L-shaped (in other words, a laterally oriented V-shaped) and is bolted to the pivot frame 17. The fixing plate 18 includes an upper arm 18a and a lower arm 18b extending rearward while diverging from each other. The upper arm 18a and the lower arm 18b are connected to each other at the front. The connection position corresponds to a first fixed position P1 described below. The rear end of the upper arm 18a is located above the pivot axis 17a and is fixed to the pivot frame 17. The rear end of the lower arm 18b is located below the pivot axis 17a and is fixed to the pivot frame 17. The fixing plate 18 is an example of a fixed portion. The portion corresponding to the fixing plate 18 may be integrally formed on the pivot frame 17.

As shown in FIG. 1, etc., the rear frame 24 is connected to the main frame 15. The rear frame 24 is arranged to extend rearwardly from the main frame 15. The rear frame 24 includes a pair of left and right seat rails 25 and a pair of left and right reinforcement rails 26.

The seat rails 25 are arranged so that their longitudinal direction is aligned with a front-rear direction. The front portion (approximately the front end) of each of the seat rails 25 is attached to the intermediate portion of the main frame 15 (specifically, the rear frame mounting portion described above). The suspension mounting portion (not shown) for mounting the rear suspension 38 is provided on the intermediate portion of each of the seat rails 25 slightly forward of the center. The reinforcement rail 26 is attached to the intermediate portion (rearward of the center) of the seat rails 25. A seat 41 for a driver to sit on is attached to the seat rails 25.

The reinforcement rails 26 are arranged so that their longitudinal direction is aligned with the forward-oblique downward orientation (rearward-oblique upward orientation). The upper rear portion of the reinforcement rail 26 is attached to the seat rails 25. The lower front portion of the reinforcement rail 26 is attached to the intermediate portion of the pivot frame 17.

Below the seat 41, a step 42 is arranged in a left-right pair for the driver seated on the seat 41 to place his/her feet. As shown in FIG. 3, etc., a pair of left and right step brackets 43 are attached to the lower portion of the pivot frame 17. The step 42 is attached on the step bracket 43.

The reinforcing frame 27 is arranged to connect the main frame 15 and the lower frame 19. The reinforcement frame 27 includes a main reinforcement frame 28, and a pair of secondary reinforcement frames 29. The main reinforcement frame 28 extends substantially in the front-rear direction and connects the rear end of the main frame 15 with the intermediate portion of the lower frame 19. The pair of secondary reinforcement frames 29 connects the intermediate portion of the main reinforcement frame 28 with the intermediate portion of the main frame 15 and the intermediate portion of the lower frame 19, each.

As shown in FIG. 1, etc., the electric vehicle 1 includes the motor unit 44 serving as a driving source and a battery 49 which is a power source for the motor unit 44. The motor unit 44 is attached to the vehicle frame 11. The battery 49 is removably supported by the vehicle frame 11. Driving force generated by the motor unit 44 is transmitted to the rear wheel 36 via a drive chain 56. This allows the electric vehicle 1 to be driven.

The motor unit 44 converts electrical power supplied from the battery 49 into driving force. As shown in FIG. 3, etc., the motor unit 44 includes a motor 45 and the output unit 47. The electrical power from the battery 49 is direct current, which is converted to alternating current by an inverter device, not shown in the figure, and then supplied to the motor unit 44.

The motor 45 is a device that converts electrical power into motive power, generating driving force (or driving torque) in response to the electrical power supply. The motor 45 in the present embodiment comprises a three-phase synchronous motor, however, it is not limited to this configuration. The motor 45 includes a motor housing 46 which is substantially cylindrical. Within the motor housing 46, a rotor and a stator are housed, which are not shown in the figure. The motor housing 46 is fixed to the vehicle frame 11. The motor 45 is configured to output a driving force generated by the interaction between the stator and the rotor to a motor shaft (not shown).

The output unit 47 includes a housing 48 that is fixed to the motor housing 46. The housing 48 is fixed to the motor housing 46 via a plurality of bolts 64. The housing 48 includes an output shaft 48d that is connected to the motor shaft of the motor 45 via a gear shifting mechanism (not shown). This configuration allows the output unit 47 to transmit (in this example, to shift) the driving force of the motor 45 and output it to the output shaft 48d. The driving force (or output of the output shaft 48d) after shifting is transmitted to the rear wheel 36 via the output shaft 48d and the drive chain 56 attached to the rear wheel 36. The gear shifting mechanism in the present embodiment is a reduction gear mechanism, but is not limited to this. Instead of a gear shifting mechanism, a transmission mechanism may be provided to transmit the driving force of the motor 45 to the output shaft 48d without shifting. The drive chain 56 is an example of a looped transmission member.

The housing 48 of the output unit 47 has an open shape towards the side (in this example, towards the left). The cover 57 that covers the output shaft 48d from the left side is attached to the housing 48. The cover 57 has a fan-like shape in a side view. The front portion of the cover 57 is fixed to the housing 48 by a plurality of bolts 65, while the rear portion thereof is open toward the rear. Through this open portion, the drive chain 56 is attached to the output shaft 48d of the output unit 47.

As shown in particular in FIGS. 3 and 4 , the cover 57 includes an extension portion 57a that extends rearwardly at the rear end. The housing 48 of the output unit 47 includes a columnar portion 48c extending leftward toward the extending portion 57a of the cover. A female screw thread is provided in the columnar portion 48c, and the extension portion 57a of the cover 57 includes a through-hole at a position overlapping the female screw thread. Furthermore, the fixing plate 18 described above includes a through-hole in a portion overlapping with the female screw thread and the through-hole. The cover 57 and the housing 48 are fixed to the fixing plate 18, and consequently to the vehicle frame 11, by bolts 66 that are inserted through the two through-holes and screwed into the female screw threads.

The position where the bolt 66 is located to fix the cover 57 and the housing 48 to the vehicle frame 11 (more specifically, the fixing plate 18) is a first fixed position P1 of the present embodiment. As shown in FIG. 3, this first fixed position P1 and the pivot axis 17a described above are in the region surrounded by the drive chain 56 in a side view. The first fixed position P1 is located forward of the pivot axis 17a. The first fixed position P1 is located rearward of the output shaft 48d of the output unit 47.

In particular, the first fixed position P1 may be located between the output shaft 48d and the pivot axis 17a in the front-rear direction, and in the side view, between a straight line connecting the axle of the rear wheel 36 and the output shaft 48d and a straight line connecting the axle of the rear wheel 36 and the pivot axis 17a. In this case, the first fixed position P1 is disposed above the former straight line and below the latter straight line.

The battery 49 is a device that stores electrical power and is capable of outputting direct current power. The battery 49 in the present embodiment includes a plurality of lithium-ion secondary batteries and is substantially prismatic in shape as a whole, but is not limited to this. The battery 49 is arranged in a forwardly inclined posture (i.e., a posture inclined such that the battery 49 extends forward as it goes upward). The battery 49 is placed on a battery tray 51.

The battery tray 51 is a container having an open top. The battery tray 51 includes a bottom wall 52 on which the battery 49 is placed, and a plurality (in this example, four) of side walls 55 rising from a peripheral edge of the bottom wall 52. The plurality of side walls 55 suppress positional displacement of the battery 49. A front protrusion 53 and a rear protrusion 54 are provided on a lower surface of the bottom wall 52. The front protrusion 53 and the rear protrusion 54 respectively protrude downward at the front and rear sides of the lower surface. As shown in FIG. 6, the front protrusion 53 and the rear protrusion 54 each have an elongated recess 53a, 54a in the left-right direction, the recesses being arcuate in a side view. The inner diameter of the recess 53a is substantially equal to the outer diameter of a first cylindrical member 59 described later, and the inner diameter of the recess 54a is substantially equal to the outer diameter of a second cylindrical member 61 described later. By placing the front protrusion 53 and the rear protrusion 54 on the first cylindrical member 59 and the second cylindrical member 61, the battery tray 51 and the battery 49 can be supported by the first cylindrical member 59 and the second cylindrical member 61.

As shown in FIG. 6, the electric vehicle 1 includes a pair of left and right brackets 58. Each of the pair of left and right brackets 58 is plate-shaped and extends substantially in the vertical direction. The pair of left and right brackets 58 are fixed to the vehicle frame 11 and the motor housing 46. As a result, the motor 45 is fixed to the vehicle frame 11 via the brackets 58.

The bracket 58 is fixed to the main reinforcement frame 28 by a plurality of bolts 67 shown in FIG. 3, etc. More specifically, the main reinforcement frame 28 has a first fastening bracket 28a protruding downward, and the bracket 58 is fixed to the first fastening bracket 28a by two bolts 67. This fixed position is a fifth fixed position P5 in the present embodiment. The first fastening bracket 28a is located forward of the connection portion with the secondary reinforcement frame 29 of the main reinforcement frame 28.

Moreover, in the vicinity of the fifth fixed position P5 (more specifically, on the side of the fifth fixed position P5 relative to the vertical center of the bracket 58), the bracket 58 is fixed to the motor housing 46. This fixed position is a second fixed position P2 in the present embodiment. That is, at the second fixed position P2, the first cylindrical member 59 extending in the left-right direction (or vehicle width direction) is provided between the motor housing 46 and the bracket 58, as shown in FIG. 6. The first cylindrical member 59 includes a first through-hole (not shown) extending in the left–right direction. Further, the motor housing 46 has a first mounting portion 46a provided at a position corresponding to the second fixed position P2. The first mounting portion 46a includes a second through-hole (not shown) extending in the left–right direction. The first through-hole and the second through-hole are arranged in the left-right direction at the second fixed position P2. The pair of left and right brackets 58 are fixed to the motor housing 46 at the second fixed position P2 by a first fastening member (first through-bolt) 69 that is inserted through the first through-hole and the second through-hole. The head of a first through-bolt 69 is located on the left side of the left bracket 58, and the distal end of the shaft portion is located on the right side of the right bracket 58. A first nut 74 is attached to the distal end of the shaft portion of the first through-bolt 69.

The bracket 58 is fixed to the lower lower frame 22 by a plurality of bolts 68 shown in FIG. 3 etc. More specifically, the lower lower frame 22 has a second fastening bracket 22a protruding rearward-oblique upward, and the bracket 58 is fixed to this second fastening bracket 22a by two bolts 68. This fixed position is a fourth fixed position P4 in the present embodiment.

Further, in the vicinity of the fourth fixed position P4 (more specifically, on the side of the fourth fixed position P4 relative to the vertical center of the bracket 58), the bracket 58 is fixed to the motor housing 46. This fixed position is a sixth fixed position P6 in the present embodiment. That is, at the sixth fixed position P6, a third cylindrical member 62 extending in the left-right direction is provided between the motor housing 46 and the bracket 58, as shown in FIG. 6. The third cylindrical member 62 includes a fifth through-hole (not shown) extending in the left–right direction. The motor housing 46 has a third mounting portion 46b provided at a position corresponding to the sixth fixed position P6. The third mounting portion 46b includes a sixth through-hole (not shown) extending in the left–right direction. The pair of left and right brackets 58 are fixed to the motor housing 46 at the sixth fixed position P6 by a third fastening member (third through-bolt) 72 that is inserted through the fifth through-hole and the sixth through-hole. The head of a third through-bolt 72 is located on the left side of the left bracket 58, and the distal end of the shaft portion is located on the right side of the right bracket 58. A third nut 76 is attached to the distal end of the shaft portion of the third through-bolt 72.

The housing 48 of the output unit 47 is also fixed to the vehicle frame 11 at positions different from the first fixed position P1 (specifically, the third fixed position P3 and a seventh fixed position P7 shown in FIG. 3). In the present embodiment, the third fixed position P3 is located above the first fixed position P1, and the seventh fixed position P7 is located below the first fixed position P1. The third fixed position P3 and the seventh fixed position P7 are located rearward of the second fixed position P2. The third fixed position P3 and the seventh fixed position P7 are, in a side view, located outside the region surrounded by the drive chain 56. The third fixed position P3 and the seventh fixed position P7 are located between the output shaft 48d and the pivot axis 17a in the front-rear direction.

In the third fixed position P3, the second cylindrical member 61 extending in the left-right direction is provided between the housing 48 of the output unit 47 and the vehicle frame 11 (more specifically, the pivot frame 17), as shown in FIG. 6. The second cylindrical member 61 includes a third through-hole (not shown) extending in the left–right direction. Further, the housing 48 has a second mounting portion 48a provided at a position corresponding to the third fixed position P3, as shown in FIGS. 3 and 5 . The second mounting portion 48a includes a fourth through-hole (not shown) extending in the left–right direction. Although the second mounting portion 48a is not shown in FIG. 6, the third through-hole and the fourth through-hole are arranged in the left-right direction at the third fixed position P3. The housing 48 is fixed to the pivot frame 17 at the third fixed position P3 by a second fastening member (second through-bolt) 71 that is inserted through the third through-hole and the fourth through-hole. The head of the second through-bolt 71 is located on the left side of the left pivot frame 17, and the distal end of the shaft portion is located on the right side of the right pivot frame 17. A second nut 75 is attached to the distal end of the shaft portion of the second through-bolt 71.

In the seventh fixed position P7, the housing 48 of the output unit 47 has a fourth mounting portion 48b as shown in FIG. 3. The fourth mounting portion 48b includes a seventh through-hole (not shown) extending in the left-right direction. In the seventh fixed position P7, the vehicle frame 11 includes a pair of left and right third fastening brackets 11a provided in the connection portion (not shown) that connects the left and right pair of pivot frames 17. The fourth mounting portion 48b of the housing 48 is located between the pair of left and right third fastening brackets 11a. Each third fastening bracket 11a includes an eighth through-hole (not shown). The seventh through-hole and the eighth through-hole are arranged in the left-right direction at the seventh fixed position P7. The housing 48 is fixed to the vehicle frame 11 at the seventh fixed position P7 by a fourth fastening member (fourth through-bolt) 73 that is inserted through the seventh through-hole and the eighth through-hole. The head of the fourth through-bolt 73 is located on the left side of the left third fastening bracket 11a, and the distal end of the shaft portion is located on the right side of the right third fastening bracket 11a. A fourth nut 77 is attached to the distal end of the shaft portion of the fourth through-bolt 73.

The battery 49 and the battery tray 51 described above are supported by the first cylindrical member 59 provided in the second fixed position P2 and the second cylindrical member 61 provided in the third fixed position P3. The third fixed position P3 is located rearward and above the second fixed position P2, and the battery 49 is supported by the first cylindrical member 59 and the second cylindrical member 61 in a forward inclined posture as described above via the battery tray 51. The inner wall surface of the recess 53a in the front protrusion 53 of the battery tray 51 contacts the outer circumference surface of the first cylindrical member 59, and the inner wall surface of the recess 54a of the rear protrusion 54 contacts the outer circumference surface of the second cylindrical member 61, thereby supporting the battery 49 and the battery tray 51. In other words, in this supporting state, a portion of each of the first cylindrical member 59 and the second cylindrical member 61 enters into the recess 53a of the front protrusion 53 or the recess 54a of the rear protrusion 54 of the battery tray 51. As a result, displacement of the battery tray 51 is suppressed.

As described above, the electric vehicle 1 of the present embodiment includes the vehicle frame 11, the swing arm 37, the rear wheel 36, the motor 45, the output unit 47, and the drive chain 56. The vehicle frame 11 includes the pivot axis 17a. The swing arm 37 is pivotably connected to the pivot axis 17a. The rear wheel 36 is rotatably supported by the swing arm 37. The motor 45 is fixed to the vehicle frame 11. The output unit 47 includes the housing 48 that is fixed to the motor 45. The output unit 47 transmits the driving force of the motor 45 and outputs the driving force to the output shaft 48d provided in the housing 48. The drive chain 56 is loop-shaped and is attached to the output shaft 48d and the rear wheel 36. The drive chain 56 transmits the output of the output shaft 48d to the rear wheel 36. The housing 48 is fixed to the vehicle frame 11 at at least the first fixed position P1. The pivot axis 17a and the first fixed position P1 are located, in a side view, within the region surrounded by the drive chain 56.

As a result, mechanical loads acting on the rear wheel 36 from the road surface or the like are transmitted via the drive chain 56 to the output shaft 48d provided in the housing 48 of the output unit 47. Since the housing 48 including the output shaft 48d is fixed to the vehicle frame 11 at least at the first fixed position P1, the mechanical load can be supported by the vehicle frame 11. Here, the first fixed position P1 is within the region surrounded by the drive chain 56 together with the pivot axis 17a in the side view. Thus, the housing 48 of the output unit 47 is fixed near the pivot axis 17a, that is, to a highly rigid portion of the vehicle frame 11. Therefore, the mechanical load transmitted to the output shaft 48d can be supported particularly stably. Furthermore, since the housing 48 is fixed to the motor 45, the above mechanical load is also transmitted to the motor 45. Since the motor 45 is fixed to the vehicle frame 11, the mechanical load transmitted to the motor 45 can also be supported by the vehicle frame 11. As described above, the mechanical load acting on the rear wheel 36 is transmitted to the housing 48 of the output unit 47 and the motor 45 via the drive chain 56. However, since both the housing 48 and the motor 45 are fixed to the vehicle frame 11, the mechanical load can be stably supported by the vehicle frame 11.

The electric vehicle 1 of this embodiment is further provided with the cover 57 that is fixed to the housing 48 and covers the output shaft 48d. The cover 57 is fixed to the vehicle frame 11.

Thereby, the housing 48 of the output unit 47 is fixed to the vehicle frame 11 indirectly via the cover 57, in addition to being fixed directly to the vehicle frame 11 in the first fixed position P1. Therefore, the forces generated between the drive chain 56 and the output shaft 48d can be more stably received by the vehicle frame 11.

In the electric vehicle 1 of this embodiment, the cover 57 is fixed to the vehicle frame 11 at the first fixed position P1.

This allows the housing 48 and the cover 57 to be fixed to the vehicle frame 11 by a common fixing means (in this embodiment, bolts 66).

In this embodiment of the electric vehicle 1, the first fixed position P1 is on the vehicle-frontward relative to the pivot axis 17a.

This shortens the distance from the output shaft 48d to the first fixed position P1. Therefore, a moment is less likely to be generated around the first fixed position P1 by the force generated between the drive chain 56 and the output shaft 48d, and the force can be received more stably by the vehicle frame 11.

In the electric vehicle 1 of this embodiment, the vehicle frame 11 has the fixing plate 18 to which the housing 48 is fixed. The fixing plate 18 includes the upper arm 18a and the lower arm 18b that diverge from each other as the upper arm 18a and the lower arm 18b extend toward the rear of the vehicle. The upper arm 18a and the lower arm 18b are connected to each other on the front side of the vehicle. A connection position of the fixing plate 18 at which the upper arm 18a and the lower arm 18b are connected corresponds to the first fixed position P1. The vehicle rear end of the upper arm 18a is above the pivot axis 17a. The vehicle rear end of the lower arm 18b is below the pivot axis 17a.

As a result, the force generated between the drive chain 56 and the output shaft 48d is transmitted to the upper and lower portions of the pivot axis 17a in the vehicle frame 11. Therefore, the force can be stably received at the highly rigid portion where the pivot axis 17a is provided.

Further, the electric vehicle 1 of the present embodiment further includes the pair of brackets 58 and the first cylindrical member 59. The pair of brackets 58 are fixed to the vehicle frame 11 and the motor 45 on both sides in the vehicle width direction. The first cylindrical member 59 is provided between the motor 45 and the brackets 58. The first cylindrical member 59 includes the first through-hole extending in the vehicle width direction. The motor 45 includes the first mounting portion 46a. The first mounting portion 46a includes the second through-hole extending in the vehicle width direction. The first through-hole and the second through-hole are arranged in the vehicle width direction at the second fixed position P2 on the vehicle-frontward relative to the first fixed position P1. The pair of brackets 58 are fixed to the motor 45 at the second fixed position P2 by the first through-bolts 69 that are inserted through the first through-hole and the second through-hole.

This allows a portion of the motor 45 (specifically, the first mounting portion 46a and its surrounding portion) to be utilized as a cross member.

The electric vehicle 1 further includes the second cylindrical member 61. The second cylindrical member 61 is provided between the housing 48 and the vehicle frame 11. The second cylindrical member 61 includes the third through-hole extending in the vehicle width direction. The housing 48 has the second mounting portion 48a. The second mounting portion 48a includes the fourth through-hole extending in the vehicle width direction. The third through-hole and the fourth through-hole are arranged in the vehicle width direction at the third fixed position P3 that is located above the first fixed position P1 and on the vehicle-rearward relative to the second fixed position P2. The housing 48 is fixed to the vehicle frame 11 together with the second cylindrical member 61 at the third fixed position P3 by the second through-bolts 71 that are inserted through the third through-hole and the fourth through-hole.

This allows a portion of the housing 48 (specifically, the second mounting portion 48a and its surrounding portions) to be utilized as a cross member.

The electric vehicle 1 further includes the battery 49 that is a power source for the motor 45. The battery 49 is supported by the first cylindrical member 59 and the second cylindrical member 61.

This allows the battery 49 to be stably supported by the vehicle frame 11 via the first cylindrical member 59 and the second cylindrical member 61, as well as the first through-bolt 69 and the second through-bolt 71.

Moreover, the electric vehicle 1 of the present embodiment further includes the battery tray 51 on which the battery 49 is placed. The battery 49 is supported by the first cylindrical member 59 and the second cylindrical member 61 via the battery tray 51.

This allows the battery 49 to be easily attached to and detached from the electric vehicle 1.

In the electric vehicle 1 of the present embodiment, the third fixed position P3 is located above the second fixed position P2. The battery 49 is supported by the first cylindrical member 59 and the second cylindrical member 61 in a forwardly inclined posture.

This allows for a battery arrangement particularly suitable for a straddle-type vehicle.

In the electric vehicle 1 of the present embodiment, each of the pair of brackets 58 is fixed to the vehicle frame 11 at the fourth fixed position P4 located below the second fixed position P2, in addition to the second fixed position P2.

This allows the pair of brackets 58, and consequently the motor 45, to be stably supported by being fixed to the vehicle frame 11 at a plurality of positions.

While suitable embodiments of the present disclosure have been described above, the above configuration can be modified, for example, as follows. The modifications may be made independently, or two or more modifications may be combined in any manner.

The cover 57 may be fixed to the vehicle frame 11 at a position different from the first fixed position P1. The cover 57 may be fixed directly to the vehicle frame 11 without the fixing plate 18. Alternatively, the cover 57 may not be directly fixed to the vehicle frame 11.

Although the first mounting portion 46a and the third mounting portion 46b are formed to protrude outwardly from the motor housing 46 in the above embodiment, they may be modified to have a non-protruding shape. The second mounting portion 48a and the fourth mounting portion 48b are formed to protrude outwardly from the housing 48 of the output unit 47 in the above embodiment, but can be modified to have a non-protruding shape.

The configuration of the vehicle frame 11 described above is merely an example, and the vehicle frame may have a different configuration.

The present disclosure is not limited to motocross-type motorcycles, but is also applied to other motorcycles, such as naked type, cruise type, or race-type for paved roads. Furthermore, the present disclosure can also be applied to other electric vehicles other than motorcycles. Other electric vehicles include, for example, all-terrain vehicles (ATVs) primarily intended for off-road use, personal watercraft (PWC), and electric vehicles (EVs) etc.

### Aspects

The above-described embodiments are specific examples of the following aspects.

(Aspect 1) An electric vehicle comprising:
a vehicle frame having a pivot axis;
a swing arm pivotably connected to the pivot axis;
a rear wheel rotatably supported by the swing arm;
a motor fixed to the vehicle frame;
an output unit including a housing fixed to the motor, configured to transmit driving force of the motor and output that force to an output shaft provided in the housing; and
a looped transmission member attached to the output shaft and the rear wheel, configured to transmit the output of the output shaft to the rear wheel, wherein the housing is fixed to the vehicle frame at at least a first fixed position, and
the pivot axis and the first fixed position are located, in a side view, within a region surrounded by the looped transmission member.

(Aspect 2) The electric vehicle according to aspect 1 further comprising:
a cover fixed to the housing and covering the output shaft, wherein
the cover is fixed to the vehicle frame.

(Aspect 3) The electric vehicle according to aspect 2, wherein
the cover is fixed to the vehicle frame at the first fixed position.

(Aspect 4) The electric vehicle according to any one of aspects 1 to 3, wherein
the first fixed position is located vehicle-frontward relative to the pivot axis.

(Aspect 5) The electric vehicle according to aspect 4, wherein
the vehicle frame includes a fixed portion to which the housing is fixed,
the fixed portion includes an upper arm and a lower arm that diverge from each other as the upper arm and the lower arm extend toward the rear of the vehicle,
the upper arm and the lower arm are connected to each other on the vehicle-frontward, and a position of the fixed portion at which the upper arm and the lower arm are connected corresponds to the first fixed position,
a vehicle-rearward end of the upper arm is located above the pivot axis, and
a vehicle-rearward end of the lower arm is located below the pivot axis.

(Aspect 6) The electric vehicle according to any one of the aspects 1 to 5, further comprising:
a pair of brackets fixed to the vehicle frame and the motor on both sides in the vehicle width direction; and
a first cylindrical member provided between the motor and the brackets, the first cylindrical member including a first through-hole extending in the vehicle width direction, wherein the motor has a first mounting portion with a second through-hole extending in the vehicle width direction,
the first through-hole and the second through-hole are arranged in the vehicle width direction at a second fixed position on the vehicle-frontward relative to the first fixed position, and
the pair of brackets are fixed to the motor at the second fixed position by a first fastening member inserted through the first through-hole and the second through-hole.

(Aspect 7) The electric vehicle according to aspect 6, further comprising:
a second cylindrical member provided between the housing and the vehicle frame, the second cylindrical member including a third through-hole extending in the vehicle width direction, wherein
the housing includes a second mounting portion with a fourth through-hole extending in the vehicle width direction,
the third through-hole and the fourth through-hole are arranged in the vehicle width direction at a third fixed position that is located above the first fixed position and on the vehicle-rearward relative to the second fixed position, and
the housing is fixed to the vehicle frame at the third fixed position, together with the second cylindrical member, by a second fastening member inserted through the third through-hole and the fourth through-hole.

(Aspect 8) The electric vehicle according to aspect 7, further comprising:
a battery that is a power source for the motor, wherein
the battery is supported by the first cylindrical member and the second cylindrical member.

(Aspect 9) The electric vehicle according to aspect 8, further comprising:
a battery tray on which the battery is placed, wherein
the battery is supported by the first cylindrical member and the second cylindrical member via the battery tray.

(Aspect 10) The electric vehicle according to aspect 8 or 9, wherein
the third fixed position is located above the second fixed position, and
the battery is supported by the first cylindrical member and the second cylindrical member in a forwardly-inclined posture.

(Aspect 11) The electric vehicle according to any one of the aspects 6 to 10, wherein
each of the pair of brackets is fixed to the vehicle frame at a fourth fixed position located below the second fixed position, in addition to the second fixed position.

1. An electric vehicle, comprising:
a vehicle frame having a pivot axis;
a swing arm pivotably connected to the pivot axis;
a rear wheel rotatably supported by the swing arm;
a motor fixed to the vehicle frame;
an output unit including a housing fixed to the motor, configured to transmit driving force of the motor and output the driving force to an output shaft provided in the housing; and
a looped transmission member attached to the output shaft and the rear wheel, configured to transmit the output of the output shaft to the rear wheel,
wherein the housing is fixed to the vehicle frame at at least a first fixed position, and
wherein the pivot axis and the first fixed position are located, in a side view, within a region surrounded by the looped transmission member.

2. The electric vehicle according to claim 1, further comprising:
a cover fixed to the housing and covering the output shaft,
wherein the cover is fixed to the vehicle frame.

3. The electric vehicle according to claim 2, wherein the cover is fixed to the vehicle frame at the first fixed position.

4. The electric vehicle according to claim 1, wherein the first fixed position is located vehicle-frontward relative to the pivot axis.

5. The electric vehicle according to claim 4, wherein the vehicle frame includes a fixed portion to which the housing is fixed, wherein the fixed portion includes an upper arm and a lower arm that diverge from each other as the upper arm and the lower arm extend toward the rear of the vehicle, wherein the upper arm and the lower arm are connected to each other on the vehicle-frontward, and a position of the fixed portion at which the upper arm and the lower arm are connected corresponds to the first fixed position, wherein a vehicle-rearward end of the upper arm is located above the pivot axis, and wherein a vehicle-rearward end of the lower arm is located below the pivot axis.

6. The electric vehicle according to claim 1, further comprising:
a pair of brackets fixed to the vehicle frame and the motor on both sides in a vehicle width direction; and
a first cylindrical member provided between the motor and the brackets, the first cylindrical member including a first through-hole extending in the vehicle width direction, wherein the motor includes a first mounting portion with a second through-hole extending in the vehicle width direction,
wherein the first through-hole and the second through-hole are arranged in the vehicle width direction at a second fixed position on the vehicle-frontward relative to the first fixed position, and
wherein the pair of brackets are fixed to the motor at the second fixed position by a first fastening member inserted through the first through-hole and the second through-hole.

7. The electric vehicle according to claim 6, further comprising:
a second cylindrical member provided between the housing and the vehicle frame, the second cylindrical member including a third through-hole extending in the vehicle width direction,
wherein the housing includes a second mounting portion with a fourth through-hole extending in the vehicle width direction,
wherein the third through-hole and the fourth through-hole are arranged in the vehicle width direction at a third fixed position that is located above the first fixed position and on the vehicle-rearward relative to the second fixed position, and
wherein the housing is fixed to the vehicle frame at the third fixed position, together with the second cylindrical member, by a second fastening member inserted through the third through-hole and the fourth through-hole.

8. The electric vehicle according to claim 7, further comprising:
a battery that is a power source for the motor,
wherein the battery is supported by the first cylindrical member and the second cylindrical member.

9. The electric vehicle according to claim 8, further comprising
a battery tray on which the battery is placed,
wherein the battery is supported by the first cylindrical member and the second cylindrical member via the battery tray.

10. The electric vehicle according to claim 8, wherein the third fixed position is located above the second fixed position, and wherein the battery is supported by the first cylindrical member and the second cylindrical member in a forwardly-inclined posture.

11. The electric vehicle according to claim 6, wherein each of the pair of brackets is fixed to the vehicle frame at a fourth fixed position located below the second fixed position, in addition to the second fixed position.
